(19) United States
(12) Patent Application Publication
(10) Pub. No.: US 2008/0070015 A1
(43) Pub. Date: Mar. 20, 2008

(54) Method for Production of Decorative Laminates with Synchronised Grain Structure and Suitable Printing Inks

(76) Inventor: Jochen Fischer, Neuried (DE)

Correspondence Address: CONNOLLY BOVE LODGE & HUTZ, LLP, P O BOX 2207, WILMINGTON, DE, 19899, US

(21) Appl. No.: 11/631,905

(22) PCT Filed: Jul. 7, 2005
(86) PCT No.: PCT/EP05/07354

§ 371 Date: Mar. 13, 2007

(30) Foreign Application Priority Data
Jul. 8, 2004 (DE) 10 2004 033 237.1

(51) Int. Cl. B32B 27/00; B32B 29/00; B44C 5/04; C09D 11/02

(52) U.S. Cl. 428/211.1; 106/31.6; 106/31.61; 156/277

(57) ABSTRACT

Process for the production of decorative laminates having pores in register, using a printing ink which comprises an additive which prevents the wetting of the printed layer with impregnating resins, printing ink suitable for carrying out the process, and decorative laminates having pores in register which are obtainable by the process.

The invention relates to a process for the production of decorative laminates having pores in register using a printing ink which comprises an additive which prevents the wetting of the printed layer with impregnating resins. It furthermore relates to a printing ink suitable for carrying out the process, and decorative laminates having pores in register, which are obtainable by the process.

Decorative laminates are known in principle. They are used in various forms, inter alia in the construction industry and furniture industry. Wood grains are widely used as motifs; however, for example, stone, ceramic, cork or purely imaginative decorations are also customary.

For the production of decorative laminates, decorative papers are impregnated with impregnating resins, such as, for example, melamine/formaldehyde resins, and finally laminated with suitable substrate materials by means of continuous or batchwise pressing under pressure and at elevated temperature. The decorative paper can on the one hand be laminated directly with wood substrates, such as, for example, particle boards or high-density or medium-density fiber boards, but it can also first be laminated with a special thick paper, i.e. kraft paper, and the laminate obtained can be glued to a wood substrate in a second step. Further details of the production of laminates are described, for example, in “Ullmann's Encyclopedia of Industrial Chemistry, 6th Edition, Electronic Release: Wood 2.4.3.3. “Decorative Laminates”” or in U.S. Pat. No. 4,552,792 and U.S. Pat. No. 4,587,141.

The decorative papers used are produced by printing white or colored special papers by the gravure printing process, usually in the 3- or 4-color printing process, with suitable decorations. Here, the last color printed is the pore color, a dark color, such as, for example, a dark red or a dark brown, with which only the pore drawing, such as, for example, the wood grain, is printed.

To ensure that the decorative laminate gives an impression which is as true to nature as possible, the laminate is usually provided with pores in the surface. For this purpose, a corresponding pore pattern is engraved in the press plates used for pressing. During pressing of the laminate, the pattern engraved in the press plate is transferred to the surface of the decorative laminate, so that the surface, too, has a corresponding pore pattern.

Particularly in the case of cheaper products, for cost reasons the same press plate is always used even for different decorations. The engraved pores then do not correspond to the printed pore drawing.

In the case of high-quality products, the decorative laminate should, however, have “pores in register”, i.e. the printed pore drawing should—as in a natural product—correspond with the actual pores in the surface. For this purpose, it is necessary to use a separate press plate for each printed pattern. This procedure is complicated and expensive.

Furthermore, the decorative papers used also expand during printing and during impregnation with the impregnating resin, and do not always do so to the same extent, depending on the chosen conditions. Thus, even in the case of press plates adapted to the decoration, the embossed pore structure frequently does not correspond exactly to the printed pore structure.

Waxes as additives of gravure printing inks are known in principle. They are used in particular for improving the abrasion resistance and scratch resistance of the prints. Further details are disclosed, for example, in “Römpp Lexikon Lacke und Druckfarben”, Georg Thieme Verlag Stuttgart 1998, page 161. The amounts used are however small. The product brochure Luwax® AF, BASF Aktiengesellschaft, January 1995 edition, recommends, for example, from 0.8 to 1.5% by weight of wax as an additive.

It was an object of the invention to provide an improved process for the production of decorative laminates having pores in register, which process does not have the abovementioned disadvantages. It was furthermore an object to provide a gravure printing ink suitable for the process.

In a first aspect of the invention, a process for the production of decorative laminates having pores in register was accordingly found, which process comprises at least the following steps
(a) printing on a substrate material substantially comprising paper with one or more ink layers by means of the gravure printing technique using corresponding gravure printing inks at least comprising solvent, binder and colorant,
(b) impregnating the decorative paper obtained with an impregnating resin and
(c) laminating that side of the impregnated decorative paper which faces away from the printed layer with a suitable substrate material, and curing said impregnated decorative paper, under pressure and at elevated temperature,

wherein a gravure printing ink which comprises an effective amount of at least one additive which prevents the wetting of the printed layer with the impregnating resin to such an extent that pores remain in the surface of the cured decorative laminate in register with the pattern printed using said printing ink is used for printing at least one of the ink layers.

In a second aspect of the invention, decorative laminates which have pores in register and are obtainable by the process were found.

In a third aspect, a gravure printing ink which comprises at least one solvent or a solvent mixture, a binder, a colorant and one or more additives was found, at least one of the additives comprising effective amounts of a material which repels impregnating resins.

Regarding the invention, the following may be stated in detail:

For carrying out the process according to the invention, a suitable white or colored paper is first printed with the desired decoration by means of the gravure printing technique. Suitable special papers for the production of laminates are known to a person skilled in the art.

Only a single printed layer can be printed in a color, but preferably a plurality of printed layers in different colors are applied. Usually, the decoration is printed using a set of printing inks of different colors, for example by means of the 3- or 4-color gravure printing technique. The pattern may be a wood pattern; however, it may also be any other pattern, for example stone, ceramic, cork or purely imaginary patterns. The actual pore structure is usually printed with the uppermost print layer. This last ink is also known as the pore ink to the person skilled in the art and is usually a dark printing ink, for example a dark brown or a dark red.

The term “gravure printing ink” is self-explanatory and at the same time limiting. Gravure printing inks are low-viscosity printing inks which, in a manner known in principle, comprise at least solvent, binder and colorant and optionally one or more additives. They comprise relatively low-boiling solvents. The boiling point is as a rule not more than 140° C. The fundamental formulation principles of gravure printing inks are known to the person skilled in the art.

The solvent of the gravure printing ink(s) used is preferably water or a predominantly aqueous solvent mixture. Further components of predominantly aqueous solvent mixtures may be, for example, alcohols. The amount of the solvent or solvent mixture is usually from 50 to 80% by weight, based on the sum of all components of the gravure printing ink, of solvent.

The binders customary for gravure printing inks can be used as binders for the gravure printing ink used for the process according to the invention. Binders which are soluble or dispersible in water or aqueous solvent mixtures are preferably used. Examples of suitable binders include aqueous dispersions of aromatic or aliphatic polyurethanes, casein or casein derivatives, polyvinyl alcohols or polyvinyl alcohol derivatives, polymers and copolymers of acrylic acid or acrylic acid derivatives, such as, for example, acrylates. The person skilled in the art makes a suitable choice from the binders possible in principle.

Particularly preferred binders are casein and casein derivatives. It is of course also possible to use mixtures of different polymeric binders, provided that the binders chosen have no undesired properties in combination with one another. The amount of all binders is usually 5-20% by weight, based on the sum of all components of the printing ink.

Colorants which may be used are the dyes customary for gravure printing inks, in particular conventional pigments. Examples are organic pigments, such as azo, phthalocyanine or isoindoline pigments. It is also possible to us inorganic pigments, such as, for example, titanium dioxide pigments or iron oxide pigments, interference pigments, carbon blacks or metal powders and of course also mixtures of different dyes or colorants. It is also possible to use soluble organic dyes. The amount of colorant is usually 5-25% by weight, based on the sum of all components of the printing ink. In the case of a set of gravure printing inks for multicolor printing, each printing ink comprises colorants which differ in hue in a known manner and are tailored to one another.

Furthermore, the gravure printing ink may optionally comprise one or more additives and/or assistants typical for printing inks.

It is essential to the invention to use, for printing at least one of the ink layers, a gravure printing ink which comprises effective amounts of an additive which repels impregnating resins.

If a plurality of layers are printed, it is usually the uppermost print layer. However, it is also possible in the invention, in special cases, for a plurality of layers to comprise the additive and/or for not the uppermost layer but one or more layers underneath to comprise the additive.

That additive of the gravure printing ink which repels impregnating resins may be any desired additive which has a sufficient repellent effect on the impregnating resin used for the production of the respective decorative laminate, provided that the properties of the gravure printing ink are not adversely affected by the additive.

“Repellent” means that the wettability of the print layer comprising the additive with the impregnating resin is ideally completely eliminated. For the purpose according to the invention, however, it is sufficient if the wettability is reduced at least to such an extent that clearly visible pores remain in the surface. For the person skilled in the art, it is self-evident that the wettability also depends on the properties of the impregnating resin used. An additive which has a repellent effect on an impregnating resin of a certain chemical composition does not necessarily have a repellent effect, or at least does not have such a good repellent effect, on another composition. The person skilled in the art makes a suitable choice depending on the desired properties.

Impregnating resins for the production of decorative laminates are known in principle to the person skilled in the art. In particular, phenol/formaldehyde resins and melamine/formaldehyde resins may be mentioned. Melamine/formaldehyde resins and modified melamine/formaldehyde resin are particularly preferred. Such resins have no natural color and, after curing, have excellent water-repellent properties. Melamine/formaldehyde resins are described, for example, in Ullmann's Encyclopedia of Industrial Chemistry, 6^{th} Edt., 2000 Electronic Release, “Amino Resins 7.2. Melamine Resins”. Melamine/formaldehyde resins are commercially available, for example under the brand Kaurit® (BASF AG).

Waxes have proven to be very particularly useful repellent additives. Both natural and, preferably, synthetic waxes may be used. Examples of natural waxes include beeswax, paraffinic waxes, montan waxes or carnauba waxes. Examples of suitable synthetic waxes include polyethylene waxes and polypropylene waxes or the corresponding oxidized products, Teflon waxes or silicone waxes. As understood by the person skilled in the art, the term “polyethylene waxes” or “polypropylene waxes” does of course include those products which, in addition to ethylene or propylene as main components, also comprise further comonomers for fine control of the properties of the wax.

The waxes are used in the form of fine particles. Preferably, the mean particle size is ≦30 μm and more preferably ≦20 μm. Correspondingly fine particles can be produced on the one hand in situ, for example by thorough dispersing of the wax in the solvent and, if appropriate, of other components with the printing ink by means of suitable dispersing units.

Polyethylene waxes are preferably added in the form of finely divided micropowders. Micronized polyethylene waxes are commercially available, for example as aqueous dispersions. Micronized polyethylene waxes having a mean particle size of from 0.5 μm to 20 μm are preferred. Such polyethylene waxes and the aqueous dispersions thereof are commercially available, for example under the brand Luwax® (BASF AG).

The additives which repel impregnating resins are generally used in an effective amount, i.e. the amount is determined by the person skilled in the art so that a sufficient repellent effect with respect to the impregnating resin results. As a rule, at least a few percent, based on all components of the gravure printing ink, are required for this purpose, as a rule at least 2 to 3% by weight.

As a rule, waxes, in particular polyethylene waxes, are used in an amount of 6-15% by weight, based on all components of the gravure printing ink, even if, in exceptional cases, an effect can be achieved with even a smaller amount. An amount of from 8 to 14% by weight is preferred, particularly preferably from 10 to 13% by weight.

Said additives have proven very particularly useful in combination with melamine/formaldehyde resins, but also exhibit an effect with other impregnating resins, such as, for example, phenol/formaldehyde resins.

The preparation of the gravure printing ink according to the invention can be effected in a manner known in principle, by thorough mixing or dispersing of the components in conventional apparatuses, such as, for example, dissolvers, stirred ball mills or a three-roll mill. Advantageously, a concentrated pigment dispersion is first prepared with a part of the components and subsequently further processed with further components and further solvent to give the final printing ink.

After the decorative paper has been printed with the desired decoration, the decoration is processed in a manner known in principle to give a decorative laminate. For this purpose, the paper is first impregnated with the impregnating resin. The surface of the paper is thereby not wet with the impregnating resin in the regions which were printed with the printing ink comprising the repellent additive, or at least is wet to a lesser extent than the other regions.

In a further process step, the impregnated decorative paper is laminated with that side of a suitable substrate material which faces away from the printed layer, under pressure and at elevated temperature, and is cured. The two steps can be carried out in parallel, or lamination can be effected first, followed by curing.

The substrate material may be, firstly, wood substrates, such as, for example, particle boards or high-density or medium-density fiber boards. However, it may also be a special thick paper, i.e. kraft paper. In the latter case, the laminate obtained by means of the kraft paper after production is glued onto a suitable wood substrate in a further step. It is also possible for further layers to be present, such as, for example, overlay papers, i.e. very fine papers which are placed on the decorative paper. The joining and curing of the laminate are effected in conventional, heatable lamination presses. Continuous or batchwise presses may be employed here. The pressure is usually up to 30 bar, in special high-pressure presses up to 360 bar, and the temperatures may be up to 220° C. The temperature during the lamination is preferably from 150 to 190° C. Press plates having engraved pores are superfluous, and it is possible to use press plates without pores. Of course, the person skilled in the art can if desired also use press plates with pores to achieve special effects.

In the process according to the invention, the impregnating resin no longer runs on the surface, even under said conditions of pressure and temperature. The parts printed with the printing ink comprising additive remains substantially free even in the course of the lamination. This does not rule out the possibility of the diameter of the pores being slightly smaller after curing than before curing or of small amounts of impregnating resin also running into the regions comprising additive, as long as visible pores remain in the surface.

The laminate obtainable by means of the process according to the invention has pores in register, i.e. the actual pores in the surface are always present exactly at those points which were printed with the pore ink.

1-13. (canceled)

14. A process for the production of decorative laminates having pores in register, comprising at least the following steps
(a) printing on a substrate material substantially comprising paper with one or more ink layers by means of the gravure printing technique using gravure printing inks at least comprising solvent, binder and colorant,
(b) impregnating the decorative paper obtained with an impregnating resin and
(c) laminating that side of the impregnated decorative paper which faces away from the printed layer with a suitable substrate material, and curing said impregnated decorative paper, under pressure and at elevated temperature,
wherein a gravure printing ink which comprises an effective amount of at least one additive which prevents the wetting of the printed layer with the impregnating resin to such an extent that pores remain in the surface of the cured decorative laminate in register with the pattern printed using said printing ink is used for printing at least one of the ink layers.

15. The process according to claim 14, wherein a plurality of ink layers are involved, and the uppermost of the printed layers comprises the additive.

16. The process according to claim 14, wherein the solvent is water or a predominantly aqueous solvent.

17. The process according to claim 16, wherein at least one of the binders is casein or a derivative thereof.

18. The process according to claim 14, wherein the at least one additive comprises from 6 to 15% by weight of a wax.

19. The process according to claim 18, wherein the additive is a polyethylene wax.

20. The process according to claim 14, wherein the impregnating resin is a melamine/formaldehyde resin.

21. A decorative laminate obtainable by a process according to claim 14.

22. A gravure printing ink comprising at least one solvent or a solvent mixture, a binder, a colorant and one or more additives, wherein at least one of the additives comprises effective amounts of a material repelling impregnating resins.

23. The printing ink according to claim 22, wherein the solvent is water or a predominantly aqueous solvent mixture.

24. The printing ink according to claim 23, wherein at least one of the binders is casein or a derivative thereof.

25. The gravure printing ink according to claim 22, wherein the at least one additive comprises from 6 to 15% by weight of a wax.

26. The gravure printing ink according to claim 25, wherein the additive is a polyethylene wax.
